(19) United States
(12) Patent Application Publication
(10) Pub. No.: US 2005/0245250 A1
(43) Pub. Date: Nov. 3, 2005

(54) Device, system and method for detection of communication disconnection

(76) Inventor: Gidon Ebenshpanger, Judean Hills (IL)

Correspondence Address: Martin Moynihan;Anthony Castorina, Suite 207, 2001 Jefferson Davis Highway, Arlington, VA, 22202, US

(21) Appl. No.: 10/525,344

(22) PCT Filed: Feb. 19, 2004
(86) PCT No.: PCT/IL04/00161

§ 371 Date: Feb. 22, 2005

Related U.S. Application Data
(60) Provisional application No. 60/448,492, filed on Feb. 21, 2003.

(51) Int. Cl. H04Q 7/20

(52) U.S. Cl. 455/421; 455/445; 455/566

(57) ABSTRACT

A device, system and method for providing indication of a disconnect when one of a plurality of cellular telephones involved in a conversation has disconnected.

### FIELD OF THE INVENTION

The present invention relates to a device, system, and method for the detection of a disconnection between two or more communication devices engaged in communication at the time of disconnection, and in particular, to such a device, system, and method that provides notification of a communication disconnection to at least one communication device.

### BACKGROUND OF THE INVENTION

During communication between two cellular telephones, if one cellular telephone disconnects, the person on the other end may not be aware that the person to whom he is speaking, is no longer on the other line. He may continue speaking for a long time before he realizes that the other person is not responding and is no longer connected.

This frustrating scenario results because there is currently no indicator which is consistently sent to a cellular telephone when the cellular telephone on the other end has disconnected.

Cellular telephones can disconnect for a variety of reasons. If disconnection is due to technical fault with the user's own telephone, the fact that a disconnection has occurred can be quite clear. Disconnection may also be due to one or both parties entering an area of poor signal. Furthermore, disconnection may also be due to technical difficulties at the base station itself.

Unless disconnection is due to a technical fault with the user's own telephone, the user may not be certain that the disconnect has occurred until some time after it has occurred, and the user realizes that the user on the other end of the line is not responding to him. A user may continue talking for some time before he realizes that there has been a disconnect.

The problem can be especially acute when the user is not speaking directly into the cellular telephone but is using a peripheral system such as headphones, or a hands free application system instead. In such systems, it can be especially hard to detect when there has been a disconnect because the user does not hear all of the background noises that are usually heard when the user is speaking directly into a cellular telephone

### SUMMARY OF THE INVENTION

The background art does not teach or suggest a way for the user to easily be notified when a voice session ends even if the voice session ends for reasons other than a technical fault with the user's own telephone.

The background art does not teach or suggest a display indicator on a user cellular telephone which indicates to the user that a disconnect has occurred.

The background art does not teach or suggest a method for informing a user that a disconnect has occurred.

Disconnection can happen by some sort of an initiation by a user (for example if the user on the other end disconnects intentionally or unintentionally). Disconnection can also occur without an initiation because of difficulties in reception. Difficulties in reception can result from many scenarios, including but not limited to, when a subscriber travels between cells and the handoff process between cells results in the call being dropped, when the subscriber travels outside of the range of cellular telephone coverage, or when the subscriber travels to an area with poor reception due to geographical considerations. For example disconnections may occur when a subscriber travels between mountains.

The frustrations caused by disconnections can be mitigated by informing the user that a disconnect has occurred.

The aim of the present invention is that a subscriber on one end of a telephone call preferably receives an indication if a disconnect occurs. The present invention is not limited to informing a cellular telephone user of a disconnect in a voice session with another cellular telephone user. The present invention may also preferably inform a cellular telephone user of a disconnect in a voice session with a wire-line telephone.

The present invention covers a range of wireless communicators which facilitate wireless communication between users including but not limited to cellular telephones, PDAs (personal data assistants) having wireless communication capabilities, andother two way communication links such as Bluetooth. These wireless communicators may preferably be in communication with other wireless communicators or with wired communicators (e.g. wired telephones).

In some preferred embodiments of the present invention, each wireless communicator may preferably comprise a cellular telephone disconnect detector, which causes a display indicator to be generated on the display of the cellular telephone which is still connected to the base station. In an alternative preferred embodiment of the present invention, each wireless communicator may preferably comprise a cellular telephone disconnect detector, which causes an audible indicator that the cellular telephone has been disconnected from the call. In alternative preferred embodiments of the present invention, the central cellular telephone service provider may preferably notify the wireless communicator (e.g. cellular telephone), for example with a disconnect message, that a disconnect has occurred.

The present invention can preferably be implemented with any type of appropriate communication device including any type of portable telephone which is preferably combined with some type of portable computer such as a laptop or a Palm Pilot™ and is preferably enabled for wireless data transmission. Appropriate communication devices include but are not limited to, cellular telephones, Blackberry™ pagers (made by Rim in Canada), satellite phones, cordless phones, radio frequency phones such as MIRs phones and and WLL (wireless local loop) enabled telephones.

With regard to the optional but preferred implementation of the present invention with WLL enabled telephones, it should be noted that this technology is sometimes also referred to as “radio in the loop (RITL)” or “fixed-radio access (FRA)”. WLL technology can be used to connect subscribers to the public switched telephone network (PSTN) using radio signals as a substitute for fixed-line wires for all or part of the connection between the subscriber and the telephone switch. This technology may optionally be implemented by using one or more of cordless access systems, proprietary fixed radio access, and fixed cellular systems.

WLL is expected to be used increasingly as a substitute for fixed-line wires or “copper” wires (landlines) in emerging economies where half the world's population lacks plain old telephone service (POTS), because it is able to provide telephone service without the expense of installing large amounts of wire. In economies which already have such wires installed, WLL is expected to be useful as an adjunct delivery method for data and voice telephone calls.

One example of a technology according to which WLL may be implemented is CDMA (code division multiple access). Of course, as previously described, other types of technologies may optionally be used (additionally or alternatively) to implemented WLL.

### BRIEF DESCRIPTION OF THE DRAWINGS

The invention is herein described, by way of example only, with reference to the accompanying drawings, wherein:

FIG. 1A is a schematic block diagram of a preferred exemplary cellular disconnect indicator system according to the present invention;

FIG. 1B is a schematic block diagram of another preferred exemplary cellular disconnect indicator system according to the present invention;

FIG. 1C is a schematic block diagram of yet another exemplary disconnect indicator system according to the present invention.

FIG. 2A is a schematic block diagram of an exemplary preferred cellular disconnect indication method according to the present invention; and

FIG. 2B is a schematic block diagram of another exemplary preferred cellular disconnect indication method according to the present invention.

### DESCRIPTION OF THE PREFERRED EMBODIMENTS

The present invention is of a device, system and method for providing indication of a disconnect when at least one cellular telephone involved in a conversation has disconnected. The plurality of cellular telephones may comprise two cellular telephones. In other preferred embodiments of the present invention, the plurality of cellular telephones may comprise a plurality of cellular telephones on a party line or a plurality of telephones in simultaneous communication through multi-party communication. The indication of a disconnect may comprise a warning which can preferably take many forms including, but not limited to, a flashing light, a sound, a ringing, a humming, a vibration, a voice, a recorded message, a display, a visual, or some sort of mechanical effect or some combination thereof.

In preferred embodiments of the present invention the disconnect indicator may indicate a disconnect in a voice session, a disconnect in the transmission of data in an electronic game, a disconnect in the receipt or transmission of email, or a disconnect in the receipt or transmission of faxes.

For the purposes of explanation and without any intention of being limiting, a disconnect in a voice session is used as the mechanism to explain the implementation of the present invention.

The present invention can preferably be implemented with any type of appropriate communication device including any type of portable telephone which is preferably combined with some type of portable computer such as a laptop or a Palm Pilot™ and is preferably enabled for wireless data transmission. Appropriate communication devices comprise cellular telephones, Blackberry™ pagers (made by Rim in Canada), satellite phones, chordless phones, and radio frequency phones such as MIRs phones.

The present invention also provides for a device, system and method for providing indication of a disconnect when one cellular telephone involved in a conversation with at least one other telephone has disconnected.

In instances where the telephone disconnects, for example when the connection is closed intentionally, the disconnection is preferably indicated at the time the telephone disconnects. A base station may preferably receive the signal and convey it to the other telephone. When the disconnection is not intentional, (i.e. there is an interruption in signal or there is some other technical problem), then the base station detects the failed communication line with the disconnected cellular telephone and transmits a disconnect message from the to the other telephone involved in the conversation. In other alternative preferred embodiments of the present invention, the indication of a disconnect may be initiated by a disconnect detector operatively associated with the telephone which is still connected to the base station.

Alternatively and preferably, the disconnection may optionally be detected by the cellular telephone itself, which may then provide a disconnect indication to the user of the cellular telephone. For this embodiment, preferably communication of the loss of the link with one cellular telephone is not required from the base station and any connected cellular telephone.

The present invention may be implemented by adding disconnect indication software to existing servers of base stations, adding disconnect indication software to existing software in all cellular telephones and/or combining the disconnect software in the base stations with the disconnect software in the cellular telephones to inform the user when there has been a disconnect.

In another alternative preferred embodiment of the present invention, disconnect indicator functionality can be implemented in a hardware addition, which plugs into a conventional cellular telephone. In certain preferred embodiments of the present invention, the hardware addition may be added in the form of an integrated circuit chip inside the telephone. In other preferred embodiments of the present invention, the hardware addition May be added to cellular telephones in the form of an external peripheral, for example by plugging the hardware addition into the earphone jack.

Disconnect indication software could also be installed in new cellular telephones as a standard feature or a customization for those who subscribe to the disconnect indication service.

In alternative preferred embodiments of the present invention, a disconnect indication system and method may be implemented through pure software, pure hardware, or some combination thereof. To this end, an additional electronic element, as well as additional software, may be added to telephones and/or to base stations.

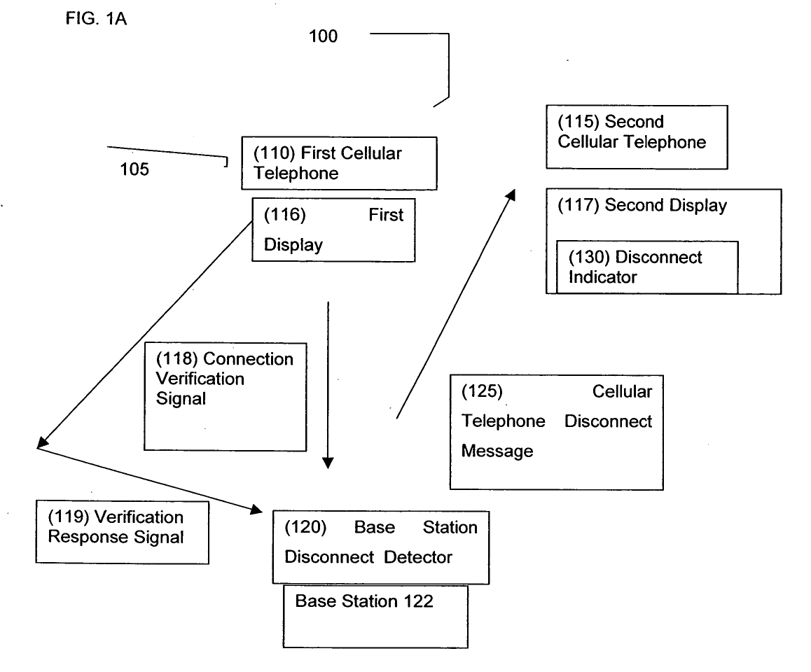

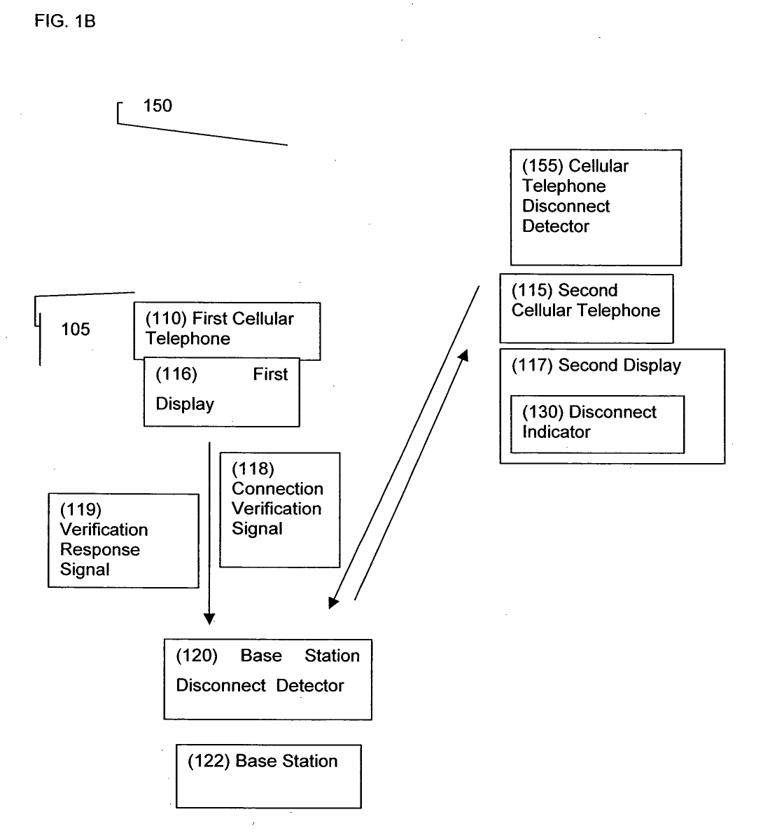

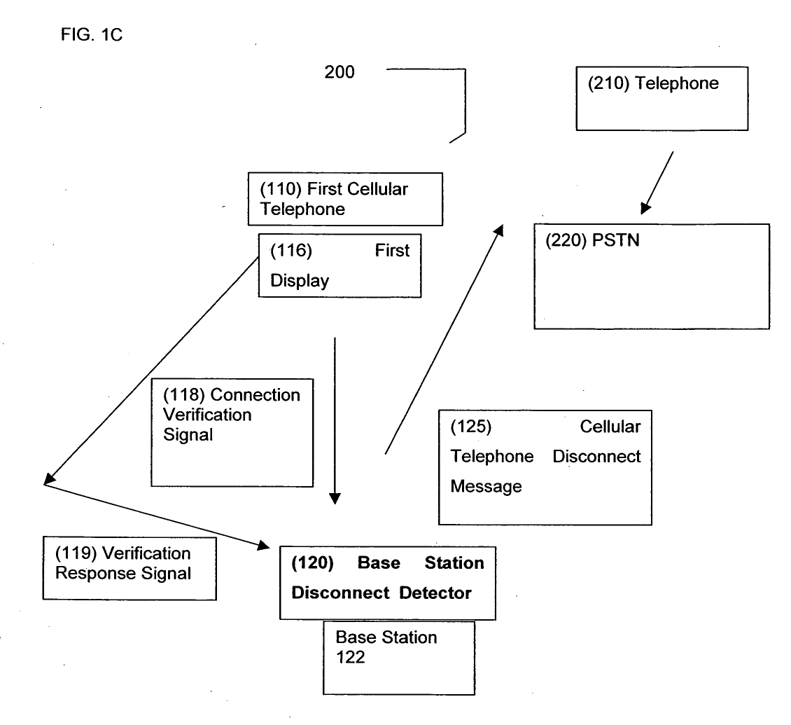

Reference is now made to FIG. 1A, which is a schematic block diagram of a preferred exemplary cellular disconnect indicator system according to the present invention.

The system, 100, of FIG. 1A comprises a plurality of cellular telephones 105. In the present example, the plurality of cellular telephones 105 comprises a first cellular telephone 110 and a second cellular telephone 115. First cellular telephone 110 comprises a first display 116. Second cellular telephone 115 comprises a second display 117. Two telephones are shown by way of example only and this example is not meant to be limiting.

The plurality of cellular telephones 105 may preferably comprise any reasonable combination of cellular telephone subscribers including all cellular telephone subscribers on a given cellular telephone network, all cellular telephone subscribers on a combination of cellular telephone networks, a subset of subscribers on a cellular telephone network who have paid an additional fee to subscribe to the service supported by the system 100, and a subset of subscribers on a combination of cellular telephone networks who have paid an additional fee to subscribe to the service supported by the system 100.

When first cellular telephone 110 disconnects (whether the first cellular telephone 110 is disconnected intentionally or unintentionally, with an initiation or without an initiation) base station disconnect detector 120 which is operatively associated with a base station 122 generates a cellular telephone disconnect message 125 which is sent to any other cellular telephone involved in a call with the disconnecting cellular telephone. In a preferred embodiment, periodically a connection verification signal 118 is generated by base station disconnect detector 120, and responded to by first cellular telephone 110 as a verification response signal 119. In the absence of verification response signal 119, base station disconnect detector 120 generates cellular telephone disconnect message 125.

As is well known in the art, there is one base station per cell, and information is relayed from cellular telephones located within the cell through the base station to a switch. The base station enables the cellular telephone system to recognize each cellular telephone subscribed to its service within a given cell so that each cellular telephone subscribed to its service can receive calls and messages that are addressed to it. The base station further enables the tracking of individual cellular telephones so that calls addressed to a particular cellular telephone can be sent to that cellular telephone. Many different methods and technologies exist for handling the registration of a cellular telephone within a cell, and the handoff of a mobile cellular telephone from one base station to another.

Turning back now to Figure. 1A, the base station disconnect detector 120 sends a cellular telephone disconnect message 125 to second cellular telephone 115. In one preferred embodiment a disconnect indicator 130 is displayed on second cellular telephone display 117. This is by way of example only and is not meant to be limiting. In another preferred embodiment disconnect indicator 130 may comprise any appropriate indication mechanism including, but not limited to, a warning, a flashing light, a sound, a ringing, a humming, a vibration, a voice, a recorded message, a display, a visual, or some sort of mechanical effect, or any combination thereof. In an alternative preferred embodiment of the present invention the user may preferably select disconnect indicator 130 from a plurality of disconnect indicators.

In preferred embodiments of the present invention, the disconnect indicator may indicate a disconnect in a voice session, a disconnect in the transmission of data in an electronic game, a disconnect in the receipt or transmission of email, or a disconnect in the receipt or transmission of faxes.

In alternative preferred embodiments of the present invention, disconnect indicator 130 may preferably be displayed when a disconnect occurs because second cellular telephone 115 lost connectivity to base station 122.

In other alternative embodiments of the present invention, disconnect indicator 130 may preferably be displayed when connectivity is still in place between the second cellular telephone 115 and the base station 122 but the voice session between first cellular telephone 110 and second cellular telephone 115 has terminated. The termination between first cellular telephone 110 and second cellular telephone 115 may preferably be recognized through non-receipt of verification response signal 119 by base station disconnect detector 120.

In alternative preferred embodiments of the present invention, display indicator 130 may explicitly indicate the reason for the disconnection.

Reference is now made to FIG. 1B, which is a schematic block diagram of another preferred exemplary cellular disconnect indicator system according to the present invention.

The system of FIG. 1B, 150, is preferably similar to the system of FIG. 1A, 100, except as described below.

When first cellular telephone 110 disconnects (whether the first cellular telephone 110 is disconnected intentionally or unintentionally, with an initiation or without an initiation), a cellular telephone disconnect detector 155 which is operatively associated with second cellular telephone 115 detects that the voice session between second cellular telephone 115 and first cellular telephone 110 has been terminated. Cellular telephone disconnect detector 155 generates display indicator 130. In a preferred embodiment such a detection is accomplished by cellular telephone disconnect detector 155 generating on a periodic basis, or in response to no received signal for a pre-determined amount of time, connection verification signal 118. Connection verification signal 118 is transmitted by second cellular telephone 115 through base station 122 to first cellular telephone 110. First cellular telephone 110 responds to the receipt of connect verification signal 118 with verification response signal 119, which is transferred to second cellular telephone 115 by base station 122 for ultimate delivery to cellular telephone disconnect detector 155. The operation of FIG. 1B is similar to the operation of FIG. 1A with the exception that connection verification signal 118 is generated by cellular telephone disconnect detector 155 instead of base station disconnect detector 120.

Optionally, the operation of FIG. 1B is combined with that of FIG. 1A thus allowing for detection by both base station disconnect detector 120 and cellular telephone disconnect detector 155. In this embodiment connect verification signal 118 comprises a source address, and verification response signal 119 is addressed to the source address of the received connection verification signal 118.

In the present example, disconnect indicator 130 is displayed on second cellular telephone display 117. In the present example, disconnect indicator 130 is shown to be a visual indicator. This is by way of example only and is not meant to be limiting. Disconnect indicator 130 may comprise any appropriate warning, which can preferably take many forms including, but not limited to, a flashing light, a sound, a ringing, a humming, a vibration, a voice, a recorded message, a display, a visual, or some sort of mechanical effect. In a preferred embodiment the user may pre-select the mechanism or combination of mechanisms from the available types supplied.

An advantage of the embodiment of the present invention illustrated in FIG. 1B is that a disconnect indicator would be displayed no matter what has caused the disconnect. Therefore, unless the disconnect was caused by a technical fault within the cellular telephone which prevents the disconnect detector and/or the disconnect indicator from working, this embodiment would still permit the user to be informed of the disconnection, regardless of the status of the connection between second cellular telephone 155 and base station 122.

Reference is now made to FIG. 1C, which is a schematic block diagram of another preferred exemplary cellular disconnect indicator system according to the present invention. The system of FIG. 1C, 200, is preferably similar to the system of FIG. 1A, 100, except as described below.

In operation telephone 210 is connected via Public Switched Telephone Network 220 to base station 122, and base station 122 is connected by the cellular network to first cellular telephone 110. Base station disconnect detector 120 operates as described above to detect a disconnect between first cellular telephone 110 and base station 122. When a disconnect is determined by base station disconnect detector 120, base station 122 sends a cellular telephone disconnect message 125 to PSTN 220, and PSTN 220 then proceeds to tear down the call.

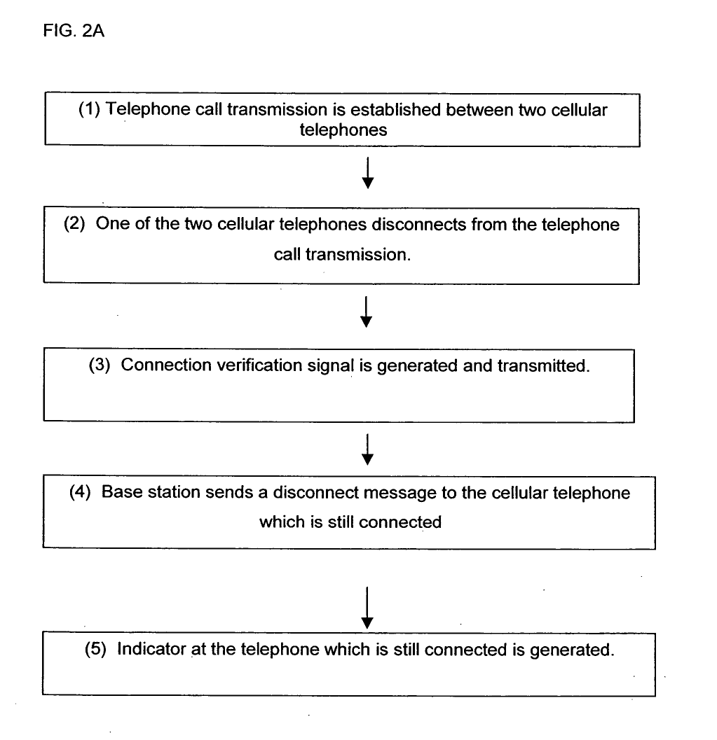

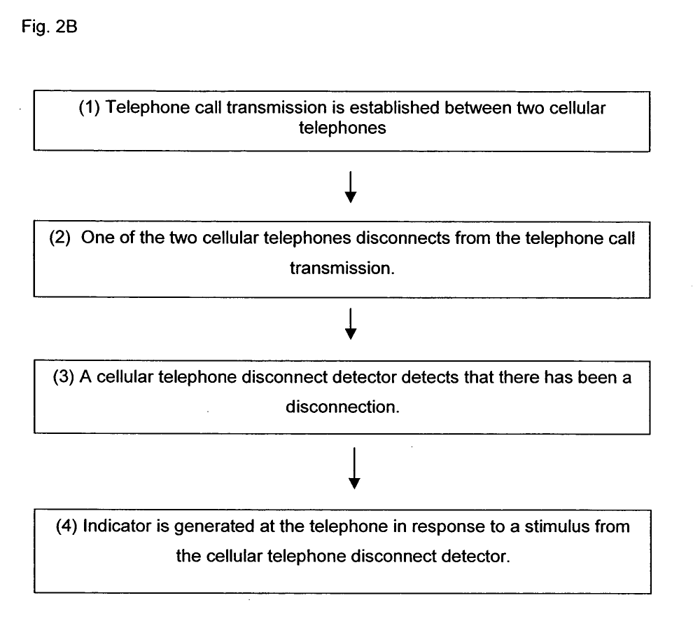

Reference is now made to FIG. 2A, which is a schematic block diagram of an exemplary preferred cellular disconnect indication method according to the present invention.

In stage 1, telephone call transmission is established between two cellular telephones.

In stage 2, one of the two cellular telephones disconnects from the telephone call transmission.

In stage 3, a connection verification signal is is generated by base station disconnect detector 120 and sent by base station 122 to the disconnected telephone.

In stage 4, after a time out counter completes, base station disconnect detector 120 has not received verification response signal 119, and base station 122 sends a cellular telephone disconnect message 125 generated by base station disconnect detector 120 to the cellular telephone which is still connected.

In stage 5, an indicator at the telephone which is still connected is generated. The indication of a disconnect may comprise a warning which can preferably take many forms including, but not limited to, a flashing light, a sound, a ringing, a humming, a vibration, a voice, a recorded message, a display, a visual, or some sort of mechanical effect or any combination therof.

Reference is now made to FIG. 2B, which is a schematic block diagram of another exemplary preferred cellular disconnect indication method according to the present invention.

In stage 1, telephone call transmission is established between two cellular telephones.

In stage 2, one of the two cellular telephones disconnects from the telephone call transmission.

In stage 3, cellular telephone disconnect detector 155 detects that there has been a disconnection, when the transmission of connection verification signal 118 does not generate a response within a predetermined time-frame.

In stage 4, disconnect indicator 130 or other appropriate means as are well known in the art indicate that there has been a disconnection in response to a stimulus from cellular telephone disconnect detector 155. The indication of a disconnect may comprise a warning which can preferably take many forms including, but not limited to, a flashing light, a sound, a ringing, a humming, a vibration, a voice, a recorded message, a display, a visual, some sort of mechanical effect or any combination therof.

It will be appreciated that the above descriptions are intended only to serve as examples, and that many other embodiments are possible within the spirit and the scope of the present invention.

1. A system for producing a disconnect indicator after one of a plurality of cellular telephones engaged in communication disconnects, the system comprising:
a cellular base station;
a connection verification generator for generating a connection verification signal;
a disconnect indicator associated with at least one cellular telephone; anda verification response detector for confirming the connection of a cellular telephone, and in the absence of a verification response confirming a disconnection of a cellular telephone,
whereby in the event of a disconnection said disconnect indicator is operated.

2. The system according to clam 1, wherein the disconnection is caused when one of the plurality of cellular telephones engaged in communication loses connectivity with the cellular base station.

3. The system according to clam 1, wherein the disconnection is caused when one of the plurality of cellular telephones engaged in communication actively disconnects.

4. The system according to claim 3, wherein one of the plurality of cellular telephones engaged in communication is intentionally disconnected by a user.

5. The system according to claim 3, wherein one of the plurality of cellular telephones engaged in communication is unintentionally disconnected by a user.

6. The system according to claim 1, wherein said disconnect indicators is chosen from the group consisting of a ringing tone, a humming, a vibration, a recorded voice message and a visual indicator.

7. The system according to claim 1, wherein the plurality of cellular telephones engaged in communication are engaged in communication through multi-party communication.

8. The system according to claim 7, wherein each of the cellular telephones which are still engaged in communication display the disconnect indicator.

9. The system according to claim 1, wherein the plurality of cellular telephones engaged in communication are engaged in communication on a party-line.

10. The system according to claim 9, wherein each of the plurality of cellular telephones which are still engaged in communication display the disconnect indicator.

11. The system according to claim 1 wherein the plurality of cellular telephones engaged in communication comprise all cellular telephone subscribers on a given cellular telephone network.

12. The system according to claim 1 wherein the plurality of cellular telephones engaged in communication comprise cellular telephone subscribers on a given cellular telephone network who have paid a fee.

13. The system according to claim 1 wherein the plurality of cellular telephones engaged in communication comprise all cellular telephone subscribers on a combination of cellular telephone networks.

14. The system according to claim 1 wherein the plurality of cellular telephones engaged in communication comprise cellular telephone subscribers on a combination of cellular telephone networks who have paid a fee.

15. A system for producing a disconnect indicator in which one of a plurality of cellular telephones engaged in communication disconnects, the system comprising:
a disconnection detector at one of the plurality of cellular telephones for detecting a disconnection to at least one other cellular telephone, and for causing said cellular telephone to produce the disconnect indicator.

16. The system according to claim 15, wherein the disconnection is caused when one of the plurality of cellular telephones engaged in communication loses connectivity with the cellular base station.

17. The system according to claim 15, wherein the disconnection is caused when one of the plurality of cellular telephones engaged in communication disconnects.

18. The system according to claim 17, wherein one of the plurality of cellular telephones engaged, in communication is intentionally disconnected by a user.

19. The system according to claim 17, wherein one of the plurality of cellular telephones engaged in communication is unintentionally disconnected by a user.

20. The system according to claim 17, wherein the plurality of cellular telephones engaged in communication are engaged in communication through multi-party communication.

21. The system according to claim 20, wherein each of the cellular telephones which are still engaged in communication display the disconnect indicator.

22. The system according to claim 17, wherein the plurality of cellular telephones engaged in communication are engaged in communication on a party-line.

23. The system according to claim 17, wherein each of the plurality of cellular telephones which are still engaged in communication display the disconnect indicator.

24. The system according to claim 17 wherein the plurality of cellular telephones engaged in communication comprise all cellular telephone subscribers on a given cellular telephone network.

25. The system according to claim 20 wherein the plurality of cellular telephones engaged in communication comprise cellular telephone subscribers on a given cellular telephone network who have paid a fee.

26. The system according to claim 20 wherein the plurality of cellular telephones engaged in communication comprise all cellular telephone subscribers on a combination of cellular telephone networks.

27. The system according to claim 20 wherein the plurality of cellular telephones engaged in communication comprise cellular telephone subscribers on a combination of cellular telephone networks who have paid a fee.

28. A method for producing a disconnect indicator in which one of a plurality of cellular telephones engaged in communication disconnects, the method comprising:
establishing a telephone call transmission between a plurality of cellular telephones;
disconnecting at least one of said plurality of cellular telephones from said telephone call transmission;
sending a disconnect message from said disconnected telephone to a base station;
sending a disconnect message from said base station to other cellular telephone; and
displaying a display indicator on said other cellular telephone.

29. A method for producing a disconnect indicator in which one of a plurality of cellular telephones engaged in communication disconnects, producing a disconnection, the method comprising:
establishing a telephone call transmission between a plurality of cellular telephones;
disconnecting at least one of said plurality of cellular telephones from said telephone call transmission;
detecting the disconnection with at least one disconnect detector operatively associated with at least one of the plurality of cellular telephones;
displaying a display indicator on the cellular telephone.

30. A system for producing a disconnect indicator after one of a plurality of communication devices engaged in communication disconnects, the system comprising:
a central communication station for communicating with the communication device;
a connection verification generator for generating a connection verification signal;
a disconnect indicator associated with at least one communication device; and
a verification response detector for confirming the connection of the communication device, and in the absence of a verification response confirming a disconnection of the communication device,
whereby in the event of a disconnection said disconnect indicator is operated.
